(19) United States
(12) Patent Application Publication
(10) Pub. No.: US 2010/0300394 A1
(43) Pub. Date: Dec. 2, 2010

(54) METAL ALLOY CASTINGS WITH CAST-IN-PLACE TUBES FOR FLUID FLOW

(75) Inventors: Guangling Song, Troy, MI (US); Bob R. Powell, JR., Birmingham, MI (US); Edward P. Becker, Brighton, MI (US); Anil K. Sachdev, Rochester Hills, MI (US); Thomas A. Perry, Bruce Township, MI (US)

Correspondence Address: General Motors Corporation;c/o REISING ETHINGTON P.C., P.O. BOX 4390, TROY, MI, 48099-4390, US

(73) Assignee: GM GLOBAL TECHNOLOGY OPERATIONS, INC., Detroit, MI (US)

(21) Appl. No.: 12/473,357

(22) Filed: May 28, 2009

(51) Int. Cl. F02F 7/00; B22D 19/04

(52) U.S. Cl. 123/195 R; 164/98; 420/591

(57) ABSTRACT

A major engine casting, such as an engine block or a cylinder head, fabricated of either magnesium or aluminum alloy, has a cast-in-place metal tube or form embedded within it. The tube or form enables circulation of liquid while substantially physically isolating the casting alloy from the circulating liquid and thereby restricting or eliminating corrosive interaction between them.

### TECHNICAL FIELD

This invention pertains to metal alloy castings with cast-in-place metal tubes for fluid circulation passages. More specifically, this invention pertains to metal alloy castings with cast-in tubes for coolant flow or other fluid flow where the metal or metal alloy composition of the tube enables forming of the casting, isolates the casting from corrosion by the fluid(s), and may provide reinforcement for the casting. As an example, a magnesium alloy engine block for a reciprocating internal combustion engine may be cast using copper tubes, stainless steel tubes, or the like as cores to provide passages around each combustion cylinder of the engine casting for the flow of a water-containing coolant, thereby protecting the magnesium alloy from corrosion by the water-containing coolant.

### BACKGROUND OF THE INVENTION

There is continual need to reduce the weight of metal castings employed in many articles of manufacture. The need is particularly acute where the castings are used in automotive vehicles. Relatively light weight metal alloys may be available for such applications. But where the cast product requires contact with a fluid for cooling, lubrication, or other purpose, consideration must be given as to the chemical effect of such fluid on the lighter alloy material.

For example, magnesium alloys (and even certain aluminum alloys) are candidates for engine cylinder blocks for gasoline-fueled internal combustion engines. But such alloys may be corroded by the water-containing coolants and the lubricants. Replacing these fluids is not practical because they are widely available and the products of years of development and effective usage. Furthermore, it is by no means certain that replacement fluids will be any less aggressive with the surrounding alloys.

There is a current need to provide for the use of light weight magnesium alloy castings, aluminum alloy castings, and other casting alloys in combination with fluids intended to be used in articles made from such metal compositions. There is a need to provide for the use of a metal alloy to make a cast article requiring contact with a fluid that is chemically incompatible with the metal composition.

### SUMMARY OF THE INVENTION

There are opportunities in the design of cast articles requiring passages for liquid flow where a preferred combination of liquid composition and cast alloy composition leads to chemical attack of casting surfaces contacted by the liquid. This invention utilizes cast-in tubes to isolate the desired cast metal from an aggressive liquid otherwise preferred for the function of the cast article.

Metal alloy cast articles are formed with cast-in tubes for fluid flow within and/or through the article. The composition of the tube is determined for the casting of a sound article, which may experience heating and cooling, with suitable interfacial contact between the tube surface and cast metal. The tube shape and composition are also selected to accommodate the passage of the fluid and the protection of the cast metal from chemical attack by the fluid. In many embodiments of the invention, the tubes will be formed of a metal or metal alloy.

One embodiment of the invention is illustrated by the casting of a magnesium alloy cylinder block for a reciprocating, internal combustion, vehicle engine. The same alloy may be used for casting the cylinder head and/or crankcase parts of the engine. The use of magnesium alloys markedly reduces the weight of engine components, but magnesium based materials are susceptible to corrosion by water-containing coolants and other fluid materials circulating through a cylinder block.

Effective water-glycol coolant formulations have been devised for circulation between an external heat exchanger and the cylinder block. The coolant is pumped through coolant channels formed around each cylinder of the cast block to remove unused heat from the action of the combustion process and reciprocating piston in each cylinder. The pistons and other moving parts of the engine may also be lubricated with a hydrocarbon-based liquid composition. This lubrication oil may also be pumped through channels in the cast engine block and the circulating hydrocarbon liquid may acquire water from the combustion processes in the engine.

In accordance with this embodiment, conduits for circulating engine fluids that may react with a selected magnesium alloy (or other selected alloy) are formed of tubes that act as casting cores, and molten magnesium alloy is cast around such tubular conduits. Where the liquid is a coolant the tubes will likely be made of a metal having suitable thermal conductivity. And the tube composition must have a solidus temperature and mechanical properties permitting molten metal to be cast around a tube structure and shape, placed like a casting core within a casting mold cavity. The strategy is for the cast metal to form a suitable bond or interface with exposed surfaces of the tube(s) for the intended function of the liquid. The tube material is selected to be compatible with the liquid that it directs through the casting, resisting unwanted chemical action with the liquid while cooperating with the function of the liquid. For example, in the embodiment of a magnesium alloy cylinder block, the cast-in tube(s) may be formed of copper, a copper-based alloy, stainless steel, or other ferrous alloy.

The shape of the tube and its wall thickness (or thicknesses) are determined for the specific article and function. For example, where the tube is to conduct coolant around a cylinder bore in a cast cylinder block, a tube of suitable internal diameter may be pre-wound like a helix for embedding in the casting around each cylinder. The cross-sectional shape of the tube may be round, square, or otherwise shaped for its cooling (and possible reinforcing) function. The tubes for each cast cylinder may be connected for preferred coolant flow for the engine design. Other tube shapes may be devised for the cylinder block embodiment. For example, the tube may be in the shape of an annular cylinder, sized to be coaxial with the engine cylinder bore, with an inner cylinder wall closely spaced around the cylinder wall of the casting, and an outer, larger diameter tubular cylinder wall spaced from the inner tubular wall for desired coolant flow up or down the common axis of the cylinders.

Thus, an object of the invention is to permit the use of a castable metal alloy material in combination with a liquid material in the making of an article of manufacture where the metal alloy and liquid would otherwise experience unwanted chemical reactions at their interfaces. By using a suitable cast-in-place barrier tube to separate a liquid from casting surfaces, the benefits of an otherwise incompatible combination of liquid and casting alloy may be exploited.

Other objects and advantages of the invention will become apparent from a description of preferred embodiments of the invention which follow in this specification. Reference will be made to illustrative drawings which are described in the next section of the specification.

### BRIEF DESCRIPTION OF THE DRAWINGS

FIG. 1 shows in phantom outline a cast cylinder block with four in-line cylinders. A representative cooling coil geometry (like FIG. 3A) is shown located within the cast block with a helical coil close to each of the four cast cylinder walls to provide progressive series fluid flow within the coils for engine cylinder cooling.

FIG. 2A shows an individual helical coil wound in a cylindrical shape for coolant flow around the cast cylinder surface of the cylinder block.

FIG. 2B illustrates a coil for a cylinder portion of a cast block where the coil is shaped for up and down coolant flow along the axis of a cylinder and progressively around the circumference of the cylinder.

FIGS. 3A and 3B show more complex fluid circulation systems based on assemblages of individual coils arranged in a series configuration. In FIG. 3A coils of like geometry are employed; in FIG. 3B, coils are again shown in series configuration but the individual coils differ in the number of turns in each coil.

FIG. 4 shows a second embodiment of a fluid circulation system based on assemblages of the individual coils arranged in parallel configuration.

FIGS. 5A-C show a cooling shell: FIG. 5A shows an overall perspective view; FIG. 5B shows a perspective sectioned view of FIG. 5A sectioned along the centerlines of the connectors; and FIG. 5C shows a view of a cross-section of the structure shown in perspective in FIG. 5B and a fragmentary view of the engine component structure cast around it.

### DESCRIPTION OF PREFERRED EMBODIMENTS

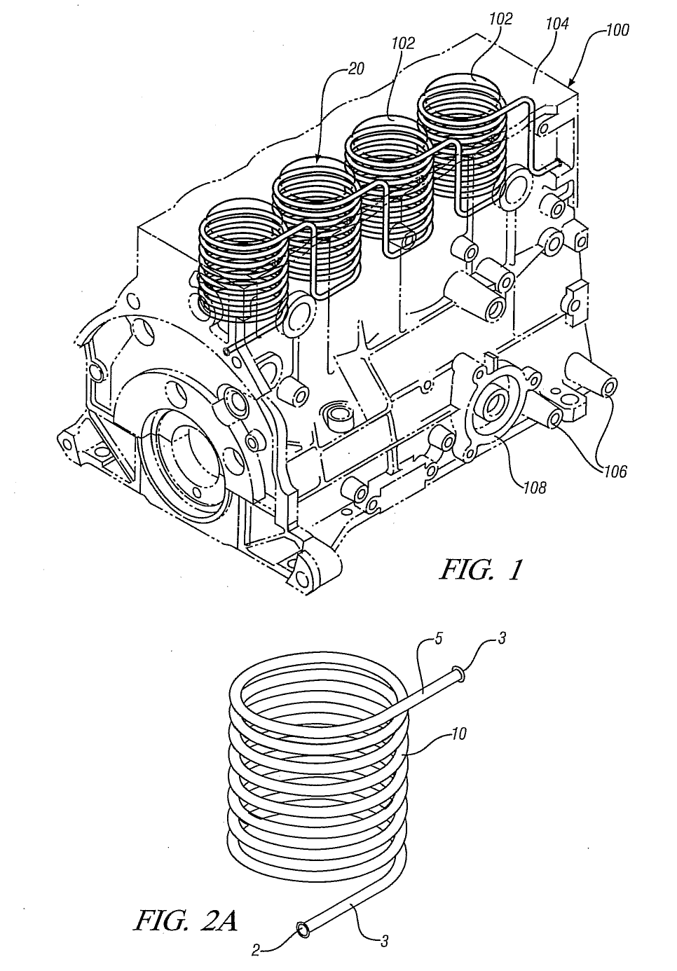

FIG. 1 is an illustrative view of the application of the invention to a representative a four-cylinder engine block generally incorporating the features and attributes of such a component. The cylinder block or engine block 100 shown in outline is a machined casting containing cylinders 102, for the pistons of a multi-cylinder reciprocating internal combustion engine. Generally the deck 104 of the engine is machined to a flat surface capable of mating to a cylinder head, not shown, with minimal gasketing. The block is also adapted to enable attachment of the cylinder head and crankcase while providing attachment points such as cored bosses 106 and mounting flanges such as shown at 108 for auxiliary mechanisms such as alternators, fuel pumps and the like, while incorporating passages for coolants and lubricants.

An interconnected tubular structure 20 intended for circulation of engine coolant with individual coils surrounding the cylinders 102 is shown wholly embedded in the cast metal alloy of cast engine block 100 to illustrate the practice of the invention. Those skilled in the art will appreciate that the tubular structure 20 constitutes only a part of a more complex circulatory system, some of which are external to the engine block, and include other circulatory paths, a water pump and a radiator, none of which are shown in this view. It will be appreciated however that while discussion will focus on the implementation depicted in FIG. 1, this is intended to be exemplary and not limiting, and that this invention may be executed on other cast engine components such as the cylinder head or on other circulatory paths through the engine block.

Engine blocks and cylinder heads are fabricated by metal casting, generally a casting process using a sand mold. In this process a form or pattern generally corresponding to the desired exterior shape and dimensions of the cast component is positioned in a container. The volume of the container not occupied by the pattern is then filled with sand, which is generally packed or tamped down. To better enable the sand to hold the shape defined by the pattern and the container and thereby to render it impervious to liquid metal the sand will generally contain a binder. The pattern is then removed leaving behind a cavity, defined by the edges of the packed sand, whose shape and dimensions replicate the pattern. These steps have created a sand mold.

In simple castings the mold cavity is then filled with liquid metal which is allowed to cool and solidify. After solidification the casting is removed from the sand mold and generally reproduces the pattern.

More complex shapes with internal features may be cast using additional sand structures known as cores (which also have sand binders), which when positioned in the mold cavity occupy that volume and thereby prohibit molten metal access. After solidification of the liquid metal these cores may be dissolved or mechanically removed from the casting to leave a cavity or cavities behind.

Conventionally-processed major engine components, head and block, which are primary applications for this invention, require extensive use of cores to develop integral fluid circulation paths. This invention involves the incorporation into the casting of previously-assembled fluid circulation passages dedicated to controlling the distribution of a single fluid, thus effectively replacing a multiplicity of temporary sand cores with a limited number of cast-in permanent cores.

Much of the cooling capability of the previously-assembled fluid passages is dictated by the interior dimensions of the passage since these will dictate the flow properties. The external dimensions are of less significance for fluid flow but will have major influence on the structural characteristics of the fluid passages. Thus through bracing and other means of structural reinforcement, such as the use of higher wall thickness tubing, the fluid passages may be rendered structurally capable of imparting significant reinforcement to the cast structure with no detriment to their role in promoting engine cooling.

Hence this invention enables: the design and routing of a fluid circulation system which may be more readily optimized to achieve its engineering goal of engine cooling or engine lubrication; the elimination of multiple cores with associated beneficial simplification of the casting process; the introduction of fluid passages whose corrosion-resisting properties are independent of the casting material; and opportunity to generally stiffen the cast structure by the introduction of fluid circulation paths with structural capability.

Specifically, when employed in internal combustion engines fabricated from creep-resistant magnesium alloys such as AJ62 (Mg-6Al-2Sr), AS21 (Mg-2Al-1Si), AXJ530 (Mg-5Al-3Ca-0.2Sr), AMT alloy SC1 (Mg—Nd—Ce—Zn—Zr), and Dead Sea Magnesium alloy MRI230D (Mg-5Al-2.5Ca-1Sn), this invention enables the use of current antifreeze, corrosion-inhibitor formulations directly in magnesium engines and obviates concerns over moisture in the lubricant. Similarly, there are some aluminum casting alloys which are not currently employed for engine components due to corrosion concerns (from water-containing engine coolant), but which would find engine casting application with this invention. Specifically, alloy compositions largely conforming to the compositions of well-known sand casting alloys A356 and B319 and high pressure die casting alloys A383 and A380 but with added alloying additions of up to 5 percent by weight of copper for improved mechanical properties would be rendered suitable for engine casting applications with this invention.

In an internal combustion engine the source of heat is the combustion of fuel in the cylinders. Thus the primary objective of any cooling scheme is to promptly remove this heat by circulating coolant, preferably as close as possible to the cylinder walls. Hence any alternative cooling scheme should also focus on prompt removal of heat from the engine block or head and thus will require the fabrication of cooling systems customized for this role.

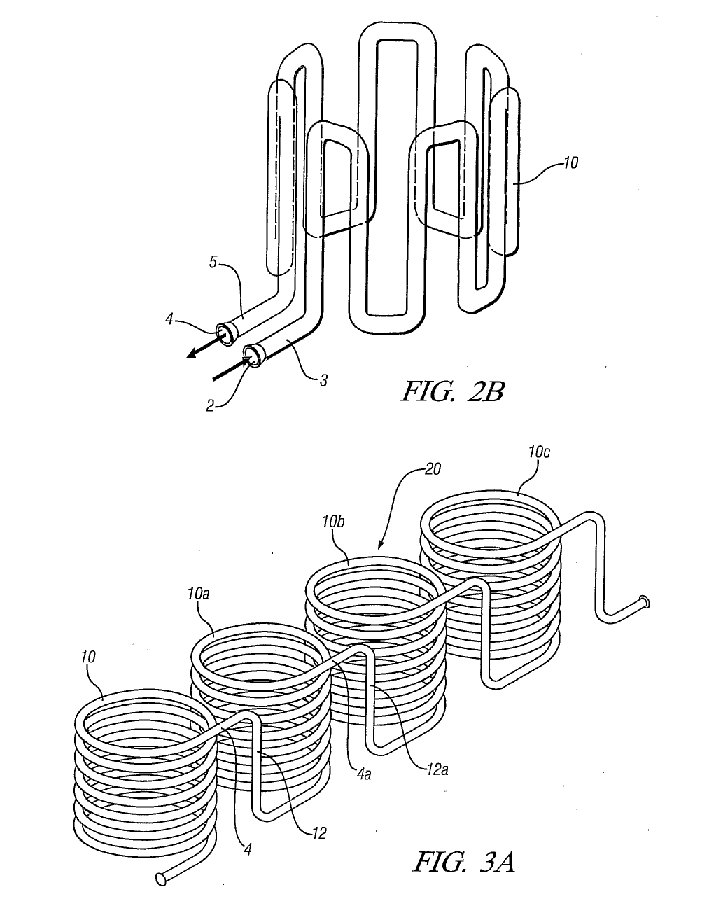

A simple approach to achieve this is to encircle the cylinder with a cooling coil. Examples of such coils 10 are shown in FIGS. 2A and 2B, both of which exhibit a generally cylindrical form, and differ only in the routing of the tubing. In FIG. 2A, the coil is generally helical about the centerline of the cylinder which it surrounds; in FIG. 2B the coil segments are oriented parallel to the cylinder axis and reverse direction at each end of the cylinder. The coil may be readily fabricated, for example, by forming tubing of any convenient section around a mandrel at room or elevated temperature. The tubing may be prepared by any convenient process but will most readily be formed through an extrusion process, generally at elevated temperature.

Note that coil 10 comprises terminal linear sections 3 and 5 with openings 2 and 4 respectively. It will be appreciated that as shown, no particular advantage attaches to the choice of opening 2 or opening 4 for the fluid inlet. Once a choice is made however, the remaining opening, will, of necessity, be the outlet. As a matter of convenience only, in the drawings and description to follow, opening 2 will be designated the fluid inlet and opening 4 will be designated the fluid outlet.

The specific coil geometries shown in FIG. 2 are exemplary only and are not intended to be limiting. Those skilled in the art will take note that many alternative coil configurations and fluid flow paths are possible. For example the coils of FIGS. 2A and 2B could have had a fluid inlet to a center coil loop, where the fluid would split into two separate paths and exiting at each end of the coil i.e. both opening 2 and opening 4 would be outlets in this configuration. Continuing this procedure, in the limit, each coil loop could be fed individually from an inlet manifold and discharge its coolant to an outlet manifold.

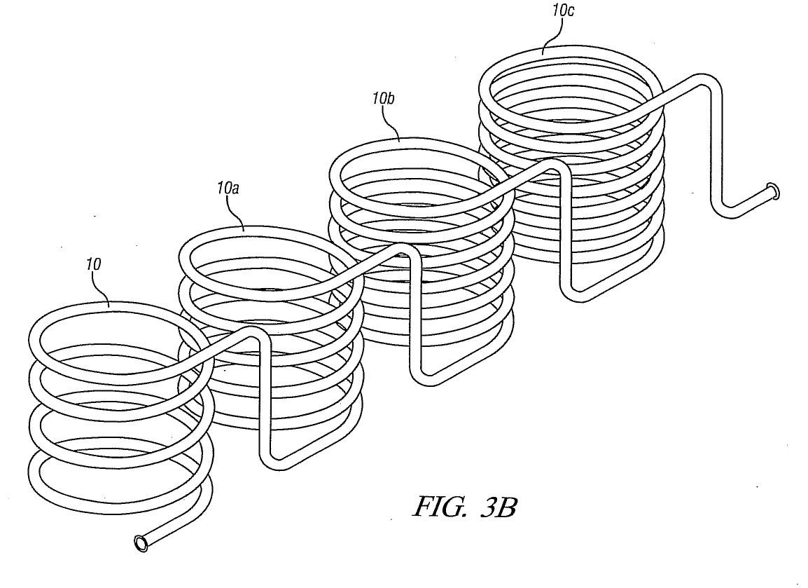

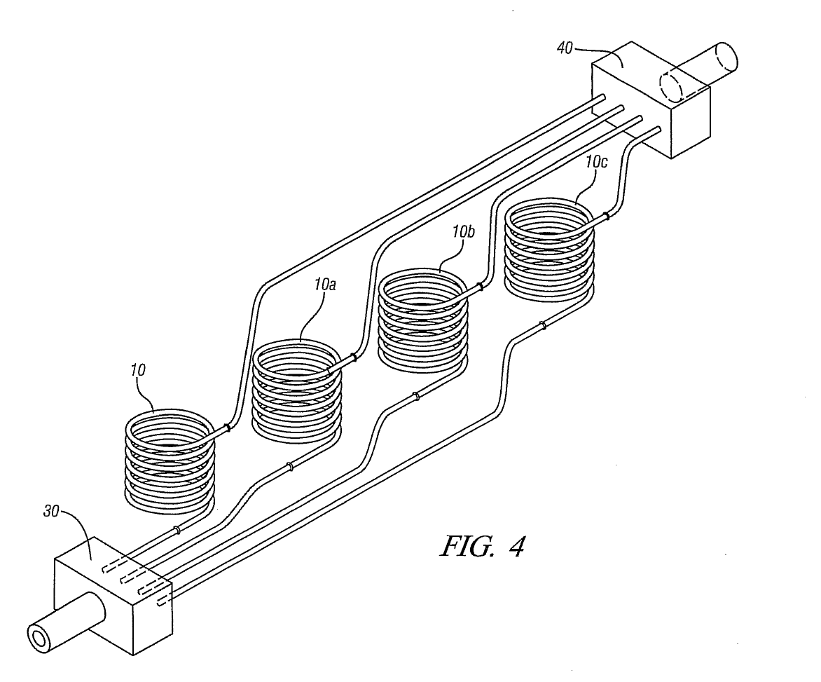

Most liquid-cooled internal combustion engines used in vehicles incorporate multiple cylinders. Thus a series of individual coils such as that shown in FIG. 2 will be required to cool multiple cylinders since for comparable cooling each cylinder will require its individual cooling coil. The coils may be arranged in a series configuration as generally shown in FIGS. 3A and 3B or in a parallel configuration as generally shown in FIG. 4.

In the series configuration 20 of FIG. 3A, the outlet 4 of coil 10 is connected through a connector 12 to the inlet 2a of coil 10a. In turn the outlet 4a of coil 10a feeds the inlet 2b of coil 10b through connector 12a. This sequence of the outlet of a particular coil supplying coolant to the inlet of the succeeding coil continues until the last coil is reached and the coolant is then routed to a suitable heat exchanger (not shown) to be cooled for further transits through the engine. This is the configuration shown in FIG. 1 as it would be incorporated in the engine block of a four-cylinder engine.

A potential difficulty with the simple series configuration of FIG. 3A is that the cooling efficiency of the coolant may decrease as it heats. Thus the cooling efficiency of coil 10 may be greater than that of coil 10c leading to a non-uniform temperature distribution in the block. This may be addressed by changing the coil geometry from coil to coil rather than simply using a fixed coil geometry. An example of this embodiment is shown in FIG. 3B which illustrates a series of coils, also in series configuration and arranged as in FIG. 3A, but in which coil 10 incorporates 4 turns, coil 10a incorporates 5 turns, coil 10b incorporates 6 turns and coil 10c incorporates 7 turns. Note that these particular coil geometries are not intended to be limiting and are chosen for purposes of illustration only. They are neither representative of, nor typical of, any specific application.

Another approach to minimizing temperature gradients is shown in the embodiment of FIG. 4 in which coolant is fed from a manifold 30 into a number of coils (10-10c) arranged in parallel where the outlet of each coil discharges into a second manifold 40 before being routed to the heat exchanger (not shown) and recirculated.

It is clear that the ability of a tubular cooling line to cool any specific location in the component will depend on the distance of the location from the cooling line. This variability in cooling efficiency may be used to advantage by routing the inlet and outlet lines to the cylindrical coils through locally hot regions, identified either experimentally or through mathematical modeling, to provide supplementary cooling. Thus in contrast to the simple routing illustrated in the figures the routing followed in practice may well be appreciably more complex.

The discrete nature of the tubular cooling passages comprising the coil may however be disadvantageous in cooling the cylinder. For maximum cooling the coil should be located close to the cylinder wall. However, if the coil is placed close to the cylinder wall, the cooling efficiency will vary inversely with distance from the coil to the cylinder wall. With compact coil geometries where individual loops are in contact with abutting loops, particularly if square tubing is used, this may not be a major concern but more open coil configurations may lead to undesired temperature gradients in the cylinder wall.

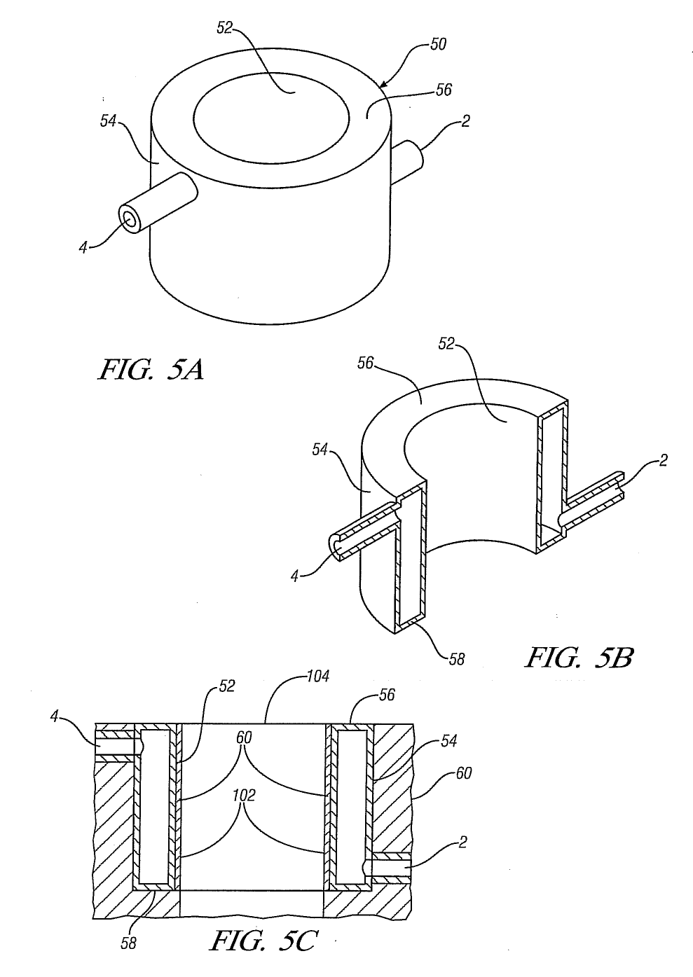

A final embodiment, which overcomes this concern, is shown in FIGS. 5A-C. FIG. 5A shows fluid circulation system 50 surrounding the cylinder and itself surrounded by a portion of cast engine block material 60 in FIG. 5C. In this embodiment fluid circulation system 50 is fabricated as a cylindrical annulus bounded by an inner cylinder 52, an outer cylinder 54 and on its ends by two planar annuluses 56 and 58. The outer cylinder 54 incorporates a fluid inlet 2 and a fluid outlet 4. If desired, the flow internal to the cylindrical annulus may be further modified or controlled by the introduction of baffles or flow restrictors or other geometric features (not shown).

As shown, the shell structure might be fabricated from two segments of tube positioned coaxially, terminated by annular sections cut or sheared from flat sheet, with entry and exit channels created from sections of yet smaller diameter tube. The whole might then be permanently assembled by a welding process. However the details of the design and fabrication of these shell structures would be readily apparent to one skilled in the art and the above description is intended to be exemplary and not limiting.

Again, a number of these shell structures, one for each engine cylinder, would be required. As in the case of the coil geometry, a series or parallel configuration may be employed requiring the use of tubing or other appropriate connections to and from the shell structure. Further, if used in a series configuration the detailed geometry of the fluid circulation within the individual shell structures might be modified to achieve balanced heat extraction from all cylinders. Finally, the routing of the inlet and outlet lines may again convey advantages in controlling local high temperature regions.

It is intended that these prefabricated fluid circulation systems will be fabricated from simple, commercially-available shapes like tubes or plates. Tubing-based structures might feasibly be fabricated from a continuous length of tubing but, more generally a series of individual elements or shapes will be assembled and permanently attached to one another to form a continuous leak-free structure capable of suitably guiding the fluid along a predetermined path under suitable urging, such as for example, from a water pump.

Positioning of the fluid circulation system is dictated by the goal of a maximizing heat extraction form the engine to the cooling fluid. Thus, as best shown in FIG. 5C, the fluid circulation system is positioned as close to the cylinder walls 102 and the deck surface of the block 104 as possible.

Although the focus has been on cooling systems and not lubrication systems it is immediately obvious that lubricant may be readily routed within the engine by incorporating similar tubular lubricant distribution systems. In the case of lubrication systems however, there is limited need for the more complex constructions illustrated for the cooling systems and simpler tube configurations should result.

The overall fluid circulation structure will be prefabricated, that is assembled as a complete interconnected structure, prior to its introduction into the casting mold and its incorporation into the casting. Further, the fluid circulation structure, once prefabricated, should be stable so that it will not distort or reorient prior to or during the casting process. Thus the structures may also incorporate stiffening or stabilizing members which have not been indicated in the figures since, if needed, they will be specific to individual castings. Also these structures will need to be positioned in the mold in a repeatable position relative to the mold cavity and any cores, for example cores for the cylinders. The general procedure for accomplishing this is well known to those skilled in the art.

A second embodiment to positioning the fluid circulation structures is to embed or encapsulate them within polystyrene foam and position the polystyrene foam within the mold. The lost foam casting process is a well known metal casting process which has been used for engine castings. This process employs a form or pattern of polystyrene foam which is not bodily removed from the sand mold to leave a mold cavity, but is instead left in the mold cavity to be removed or ‘burned out’ through contact with the molten metal. As contemplated here, the fluid circulation structure may be embedded in a polystyrene foam pattern representing the entire casting or only the circulation structure could be embedded in polystyrene foam. In the first case it would constitute a variant of the ‘Los t Foam’ cas ting process, while in the second case it would simply be a foamed insert in a conventional sand casting process.

One particularly advantageous application of incorporating prefabricated cooling passages is for the fabrication of magnesium engine components in view of antifreeze compatibility issues. Hence it should be noted that the Lost Foam process is not well-suited for use with magnesium since experience has shown that the low heat content of the magnesium is unable to supply enough thermal energy to reliably remove or ‘burn out’ all of the polystyrene foam. However if the only portion of the overall mold which contains polystyrene foam is the region incorporating the circulation structure, the more limited volume of foam to be removed may not be an impediment to the use of magnesium.

Ideally, the chemical composition of the fluid circulation structures should be guided by three considerations:

the melting point of the fluid circulation structure should be higher than the melting point of the casting material to ensure that the fluid circulation structure is not dissolved by the molten metal, or otherwise reacts detrimentally with the molten metal, during the casting process;

the casting material and the fluid circulation structure should be capable of forming a metallurgical bond to maximize the efficiency of heat transfer across the interface;

the coefficients of expansion of the casting material and the fluid circulation structure should be similar to both minimize thermal stresses and maximize the fit between the two throughout the engine operating temperature range.

Some non-limiting examples of material combinations which satisfy these criteria are: copper or stainless steel, cast in an aluminum alloy; stainless steel, cast in a magnesium alloy; aluminum, cast in an aluminum alloy. Hence similar or dissimilar materials may be used.

Similar materials may be used provided that the addition of alloying elements to aluminum or magnesium to render a suitable casting alloy for engine components will necessarily depress the melting point of the alloy relative to the pure metal.

However, metals are not poured into the mold at a temperature equal to their melting point. Rather the pouring temperature is elevated by some appropriate number of degrees, superheat. Superheat at least partially compensates for thermal losses experienced by the molten metal prior to and during its introduction into the mold. This is required so that the mold can be filled with liquid metal before solidification proceeds to the point where metal feeder channels freeze and solidify, denying access to the mold to the last-poured metal.

Thus provided the melting point of the pure metal corresponding to the primary alloying constituent of the casting metal is sufficiently high that it is higher than the pouring temperature of the casting alloy, the pure metal will not melt.

The cast metal and structure metal (for convenience the term ‘structure metal’ will be used in this section to denote the material of the fluid circulation structure, whether a tubular fabrication or fabricated from discrete components) or combinations indicated above all are capable of forming a metallurgical bond. However it will be appreciated that oxide or contaminant layers on the tubing may prevent wetting of the structure metal by the cast alloy and inhibit metallurgical bond formation. This may be addressed, if necessary, through application of a flux or other surface-active reagent to the structure metal to promote a clean surface suitable for forming the desired metallurgical bond.

The linear coefficient of thermal expansion of metals varies inversely with the melting point of the metal, higher melting point metals possessing lower linear coefficients of thermal expansion and lower melting point metals and alloys possessing higher linear coefficients of thermal expansion. Thus, the similar casting alloy and structure metal combinations will automatically have similar linear coefficients of thermal expansion. Combinations of dissimilar metals will, inevitably, lead to differences in their coefficients of thermal expansion and generate greater thermal stresses. Provided the cast engine component can sustain the generated stress, this need not be a prohibition and higher melting point structure metals may be acceptable and may confer additional advantages, for example enhanced stiffness to the component.

By way of example consider the following procedure for casting a stainless steel cooling system. The cooling system may be readily fabricated from thin wall welded or seamless tube fabricated from 304 grade austenitic stainless steel which provides excellent corrosion resistance. This grade also offers excellent weldability, enabling the cooling system to be fabricated from a single length of tubing or from a welded assemblage of tubular forms as required.

Since this is intended for a cooling application where maximum heat transfer is desired, the cooling coil should be afforded maximum opportunity to bond to the stainless steel. Hence, after appropriate cleaning and pickling of the tube outside diameter it should be coated with a suitable flux to promote bonding. Suitable fluxes are available commercially or the chloride formulation described in U.S. Pat. No. 3,728,783 may be employed.

The surface treated cooling system, preferably with its openings temporarily sealed to prevent ingress of the casting alloy, and other elements such as cores will then be positioned in a sand mold comprising dry lake sand, silica, zircon or chromite, incorporating mixtures of sulphides, fluorides and ammonium complexes to inhibit reaction of molten magnesium with the mold. Also to increase its mechanical integrity the sand mold will incorporate one of a variety of organic binders which may be urethane based. It will be appreciated that in order to achieve appropriate introduction of the molten metal to the mold and distribution of the molten metal within the mold, elements additional to the mold cavity will be required. These include sprues runners and risers.

A magnesium alloy at a pouring temperature of between 625° C. and 725° C. will be poured into to mold under a protective atmosphere of sulfur hexafluoride, generally at less than a 1% concentration, in dry air, nitrogen or carbon dioxide and allowed to solidify.

When solidified the solidified casting is removed from the sand mold, generally mechanically, and those features additional to the desired form, that is the sprue, runners and riser(s), are removed, leaving the desired cast form with the stainless steel cooling system positioned in its interior.

The benefits of this invention with respect to eliminating corrosive interaction between the cooling fluid and the engine block have been illustrated with respect to current engine block materials and current coolant formulations. Thus by practice of this invention, corrosion concerns which might guide or influence selection of both the engine casting material or coolant chemistry selection are rendered moot. A further advantage of this invention is that the benefits of employing alternate engine casting materials and/or alternate engine coolant formulations may be investigated without regard to corrosion compatibility. For example, higher performance aluminum alloys would be enabled if a higher copper content could be tolerated without corrosion. And advanced engine coolant formulations such as copper and copper oxide nanodispersions in a carrier fluid would be more attractive if corrosion compatibility with the cast engine material was not an issue.

While some preferred embodiments, have been provided to better describe the invention, these are exemplary only and should not be construed as limiting—other forms can readily be adapted by those skilled in the art. Thus the scope of the invention is limited only by the following claims.

1. A cylinder block casting or cylinder head casting for an internal combustion engine, the casting being formed of a cast magnesium alloy or aluminum alloy, the casting comprising a liquid flow passage intended for flow of a liquid composition that is chemically destructive of the cast alloy, the liquid flow passage being formed of a cast-in-place metal tube of a metal composition that isolates the cast alloy from the liquid while permitting the liquid to serve its intended function in the cylinder block or cylinder head.

2. The casting of claim 1 wherein the cast magnesium alloy is a creep resistant alloy.

3. The casting of claim 1 wherein the cast aluminum alloy contains up to 5 percent by weight of copper.

4. The casting of claim 1 wherein the metal composition of the metal tube is selected from the group consisting of aluminum or aluminum alloys, copper or copper alloys and iron or iron alloys including stainless steel.

5. The casting of claim 1 wherein the liquid composition comprises ethylene glycol and water.

6. The casting of claim 1 wherein the liquid composition comprises lubricating oil.

7. A method of imparting enhanced corrosion resistance from water- based coolants to a cast engine component fabricated of a casting alloy comprising the steps of:
selecting a material which is (i) resistant to corrosion by water-based coolants, (ii) does not react destructively with the casting alloy and (iii) has a melting point which is higher than the pouring temperature of the casting alloy;
fabricating a continuous leak-free coolant circulation system from the selected material;
treating the surface of the coolant circulation system to prepare it for reaction with the casting alloy;
placing the fabricated coolant circulation system in a mold intended for casting the engine component;
pouring the casting alloy into the mold at a selected pouring temperature; and
allowing the casting alloy to solidify and incorporate the at least one prefabricated fluid circulation system wherein the fluid circulation system is cast into the engine component.

8. The method of claim 7 wherein the casting alloy is a magnesium alloy.

9. The method of claim 7 wherein the casting material is an aluminum alloy.

10. The method of claim 7 wherein the engine component is a cylinder head.

11. The method of claim 7 wherein the engine component is an engine block.

12. The fabricated coolant circulation system of claim 7 wherein the fabricated coolant circulation system comprises a permanently-attached assemblage of structural shapes constructed to be leak-free.

13. The fabricated coolant circulation system of claim 7 wherein the fabricated coolant circulation system comprises an at least one tube constructed to be leak-free.

14. The material of claim 7 wherein the material is selected from the group consisting of aluminum, copper, steel and alloys thereof including stainless steel.

15. The method of claim 7 wherein the surface treatment comprises cleaning, etching and fluxing.

16. A cast magnesium or aluminum engine block for an internal combustion engine wherein at least one of a circulating fluid is contained within an at least one prefabricated fluid circulation system comprising a plurality of assembled helical coils of generally cylindrical form each of which surrounds a cylinder.

17. The cast magnesium or aluminum engine block of claim 16 wherein each of the plurality of assembled helical coils of generally cylindrical form comprises a like number of turns.

18. The cast magnesium or aluminum engine block of claim 16 wherein the plurality of assembled tubular coils comprises an at least one helical coil with a smaller or greater number of turns than an at least one of the remaining coils.

19. The cast magnesium or aluminum engine block of claim 16 wherein the plurality of assembled helical coils is arranged in series configuration.

20. The cast magnesium or aluminum engine block of claim 16 wherein the plurality of assembled helical coils is arranged in parallel configuration.
